(19) United States
(12) Patent Application Publication
(10) Pub. No.: US 2026/0161042 A1
(43) Pub. Date: Jun. 11, 2026

(54) COMB SOURCE WITH IMPROVED CONTROL

(71) Applicants: Tin Komljenovic, Goleta, CA (US); Minh Tran, Goleta, CA (US); Chong Zhang, Santa Barbara, CA (US)

(72) Inventors: Tin Komljenovic, Goleta, CA (US); Minh Tran, Goleta, CA (US); Chong Zhang, Santa Barbara, CA (US)

(21) Appl. No.: 18/970,061

(22) Filed: Dec. 5, 2024

(51) Int. Cl. G02F 1/313

(52) U.S. Cl. CPC G02F 1/313; G02F 2201/58; G02F 2202/32; G02F 2203/15; G02F 2203/54; G02F 2203/70

(57) ABSTRACT

A device has a first element with a first semiconductor laser; a second element with two resonators and resonator tuner elements, producing a comb output; a third element with a 1:N splitter (N>=3) providing N third element outputs; a fourth element with N semiconductor optical amplifiers, generating N fourth element outputs; and a fifth element, comprising N waveguides, providing N comb source outputs. X % of the laser output is coupled to the second element, the comb output is coupled to the third element, the third element outputs are coupled to the fourth element and Y % of each fourth element output is coupled to the fifth element. The first, second, third, fourth and fifth elements are realized as at least part of a photonic integrated circuit.

### FIELD OF THE INVENTION

The present invention relates to photonic integrated circuits. More specifically, certain embodiments of the invention relate to photonic integrated circuit based comb sources with improved control and performance.

### BACKGROUND OF THE INVENTION

Lasers play a pivotal role in modern communications, particularly in fiber optic and free-space optical communications. In fiber optic communications, lasers are used as light sources to transmit data through optical fibers while in free-space, optical communications data is transmitted through the air or space without the need for physical cables. These lasers, historically typically semiconductor lasers like vertical-cavity surface-emitting lasers (VCSEL) or distributed feedback (DFB) lasers, emit light at specific wavelengths that match the transmission window of the optical fibers, atmosphere and/or space. The high coherence and narrow linewidths of laser light allow for efficient and high-speed data transmission, making it possible to achieve high data rates.

A VCSEL or DFB laser typically emits at a single frequency, often called a carrier frequency, that is modulated to carry data, where the amount of data carried is related to the modulation format and speed of modulation. There has been a significant increase in the amount of data that can be carrier over a single frequency by using faster and faster modulation techniques and higher and higher order modulation formats, but as the need for bandwidth continues to increase, further improvements in capacity are needed. One way to further improve the capacity of the system, using either fiber or free-space implementations, is to use multiple wavelengths each of which fits into the broad spectral ranges over which fiber and free-space are transparent. Such systems are called wavelength division multiplexing (WDM) systems and convey multiple optical signals using a different carrier wavelength (or color) of laser light for each. Each wavelength carries a separate data stream that can be independently modulated, allowing multiple signals to be transmitted simultaneously without interfering with each other. Such systems have been used in both short and long-haul communications and have achieved extremely high bandwidths exceeding hundreds of terabits per second (Tbps).

A challenge with systems that utilize many wavelengths is related to their need to have multiple lasers, each for one wavelength, which increases the cost of the systems. The development of multi-wavelength sources has been pursued to address this problem, with approaches including implementing arrays of lasers with a combiner in a single chip, using mode-locked lasers and/or resonator-based comb-based sources. Resonator-based comb-based sources are of special interest as a large number of wavelengths can easily be generated using a single-wavelength source and a resonator, where the spacing of those generated wavelengths is controlled by the roundtrip time inside the resonator. Of special interest are micro-resonator based frequency comb sources that can be made in typical semiconductor processes with low cost, but there are challenges related to fabrication variation leading to variation in the efficiency of generation of comb lines (e.g. pump power required) and non-uniform power distribution of the comb lines (e.g. due to dispersion variations). This negatively impacts yield, resulting in more expensive systems.

For an optimal, high-capacity communication system, the resonator-based comb source would generate a large number of comb lines, often spaced on standard ITU grids (50 GHz, 100 GHz, 200 GHz), with essentially identical powers in each line. Furthermore, the source would be fabricated using standard wafer-scale semiconductor processes to enable scaling and low cost, while also enabling advanced control to optimize the performance and account for process variations of a typical semiconductor process.

The present invention is directed towards chip-scale micro-resonator based comb sources that provide the above mentioned characteristics and address the needs of current and future WDM communication systems.

### BRIEF DESCRIPTION OF THE DRAWINGS

FIG. 1 shows an illustrative micro-resonator-based comb source architecture according to some embodiments of the present invention.

FIG. 2 shows some examples of a micro-resonator-based sub-system according to some embodiments of the present invention.

FIG. 3 shows an illustrative cross-section of a photonic integrated circuit comprising a micro-resonator-based comb source architecture according to some embodiments of the present invention.

FIG. 4 illustrates a calibration process for the micro-resonator-based comb source according to some embodiments of the present invention.

FIG. 5 shows some calculations and measurements relevant to micro-resonators made from silicon-nitride waveguides.

FIG. 6 shows some additional embodiments of micro-resonator-based comb source architectures according to some embodiments of the present invention.

FIG. 7 shows one embodiment of a micro-resonator-based comb source architecture according to some embodiments of the present invention.

### DETAILED DESCRIPTION

Described herein are embodiments of a platform for realization of photonic integrated circuit-based comb source with improved control and performance.

In the following detailed description, reference is made to the accompanying drawings which form a part hereof, wherein like numerals designate like parts throughout, and in which are shown by way of illustration embodiments in which the subject matter of the present disclosure may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

The description may use perspective-based descriptions such as top/bottom, in/out, over/under, and the like. Such descriptions are merely used to facilitate the discussion and are not intended to restrict the application of embodiments described herein to any particular orientation. The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The term “coupled with,” along with its derivatives, may be used herein. “Coupled” may mean one or more of the following. “Coupled” may mean that two or more elements are in direct physical, electrical, or optical contact. However, “coupled” may also mean that two or more elements indirectly contact each other, but yet still cooperate or interact with each other, and may mean that one or more other elements are coupled or connected between the elements that are said to be coupled with each other. The term “directly coupled” means that two or more elements are in direct contact in at least part of their surfaces. The term “butt-coupled” is used herein in its normal sense of meaning an “end-on” or axial coupling, where there is minimal or zero axial offset between the elements in question. The axial offset may be, for example, slightly greater than zero in cases where a thin intervening layer of some sort is formed between the elements, such as e.g. thin coating layer typically used to provide high-reflectivity or anti-reflectivity functionality. It should be noted that the axes of two waveguide structures or elements need not be colinear for them to be accurately described as being butt-coupled. In other words, the interface between the elements need not be perpendicular to either axis.

Furthermore, the butt-coupling can be partial, meaning that the two waveguide structures and the modes they support are not optimized for maximum modal overlap, but are misaligned in at least one axis.

No adiabatic transformation occurs between butt-coupled structures.

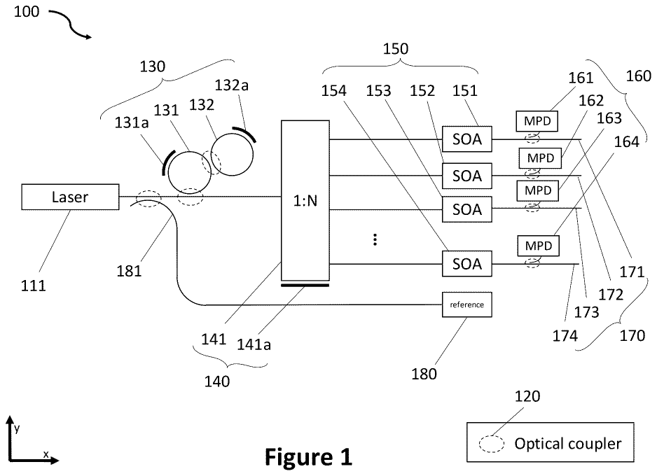

FIG. 1 shows a photonic integrated circuit (PIC) micro-resonator-based comb source 100 according to some embodiments of the present invention, comprising laser 111, resonator sub-system 130, splitter sub-system 140, semiconductor optical amplifier (SOA) sub-system 150, optional monitor photodetector (MPD) sub-system 160, optical outputs 170, and optional reference sub-system 180. Coupling between some elements is facilitated by optical couplers 120.

Laser 111 can be any type of semiconductor laser suitable for pumping the resonators. Examples of such lasers include Fabry-Pérot lasers (typically self-injection locked to provide single-frequency operation), single-frequency lasers such as distributed-feedback lasers (DFB) and distributed Bragg reflector lasers (DBR), widely tunable lasers such as ring-resonator-based Vernier tunable lasers, sampled grating distributed Bragg reflector (SG-DBR) lasers, and others.

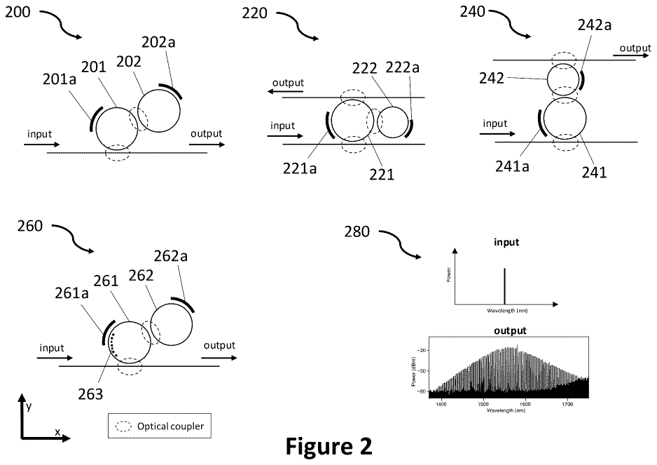

The laser is coupled to the resonator sub-system 130. The resonator sub-system 130 comprises at least two resonators 131 and 132 that are coupled together. Multiple arrangements of coupling between the bus waveguides from the laser 111 to the resonators and then to splitter sub-system are possible as will be described in more detail with the help of FIG. 2. In the embodiments shown in FIG. 1 the resonator 131 is coupled to the laser in so-called all-pass configuration, while resonator 132 is coupled to resonator 131 as an “auxiliary” resonator to help optimize the comb performance. The use of coupled resonators enables more complex nonlinear dynamics, and a versatile capability for dispersion engineering which can be used to optimize both the number of teeth in the comb and the power distribution across them.

In some embodiments, the resonator can self-injection lock the laser. The resonator, due to random and/or intentional perturbations, reflects a small amount of light back into the laser. This reflected light interferes with the light already in the laser cavity, effectively “locking” the laser's frequency to the resonator's frequency. This can help ensure single-frequency output from the laser (e. g if a Fabry-Pérot laser is used), to improve the noise characteristics of the laser output (e.g. reduce linewidth and/or relative intensity noise), and to improve the laser resilience to any feedback/reflections downstream from the resonator.

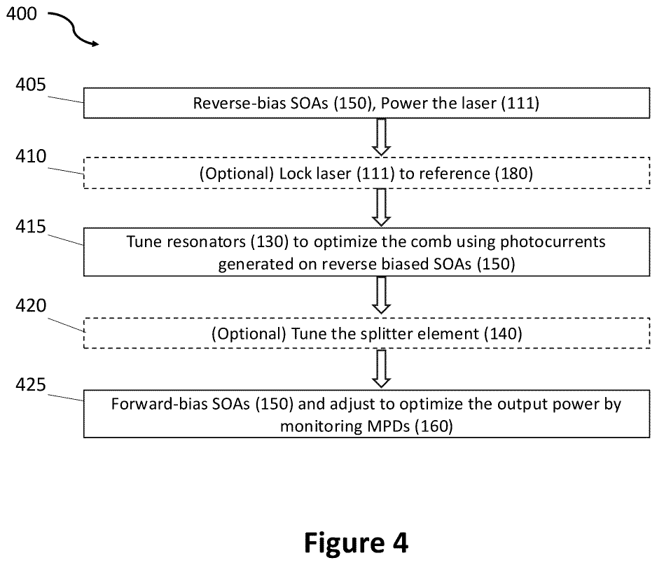

Resonator subsystem 130 accepts the input from the laser 111, which is typically operated in continuous wave, at a single frequency, and converts that through non-linear effects and power buildup inside resonators 131, 132 to multiple frequencies that are typically spaced by the free-spectral range of the resonator which is defined as the inverse of the round-trip time. This will be explained in more detail with the help of FIG. 2, but in all embodiments, the output of a laser, which is typically single frequency, is converted to at least 3 or more frequencies or comb-lines via the resonator sub-system 130. In some embodiments, the number of comb-lines is 16, 32, 64, or even larger than 100. To allow for additional control of the resonators and the complete comb source, as will be explained in more detail below in the discussion of FIG. 4, each resonator has a tuner element where tuner element 131a can tune the resonance of the resonator 131 and tuner element 132a can tune the resonance of the resonator 132. In cases where there are more than two resonators, there would typically be the same number of tuning elements as there are resonators.

The output from resonator sub-system 130 is delivered to splitter sub-system 140. whose purpose is to demultiplex the received output of resonator sub-system 130. Each of the generated frequencies reaching splitter sub-system 140 is coupled out from sub-system 140 into one and only one corresponding splitter channel waveguide, as a dominant comb frequency for that channel (suppressing other frequencies by at least 10 dB), and is then delivered to a corresponding SOA, as described below. The number of splitter channel waveguides leaving splitter element 141 is N. N can be any number from 3 to greater than 200 or more. In some embodiments, N=16, or 64 or 128. In some embodiments, as shown in FIG. 1, splitter sub-system 140 comprises splitter element 141 and tuner element 141a. Examples of practical splitter elements 141 include arrayed waveguide gratings (AWGs), Echelle gratings, ring-resonators configured as add-drop filters, unbalanced Mach-Zehnder interferometers, inverse-design passive components providing suitable de-multiplexing functionality and/or other similar components that can provide frequency selectivity. Tuner 141a provides a tuning capability that can be used to align the splitter element 141 to improve the performance of the system as will be explained with the help of FIG. 4.

The outputs of the splitter channel waveguides are coupled to SOA sub-system 150. SOA sub-system comprises N SOAs, four of which (151-154) are shown in FIG. 1. Each SOA receives light from one and only one corresponding splitter channel waveguide, carrying the dominant comb frequency for that channel (plus, if there is any significant crosstalk in the splitter sub-system, one or more other frequencies at power levels at least 10 dB lower than that of the dominant comb frequency) and delivers an amplified version of that light to one and only one corresponding SOA channel waveguide. Furthermore, as the gains of the SOAs can be individually controlled, the SOA sub-system can be used to equalize the power at the dominant comb frequency for each SOA channel waveguide leaving subsystem 150, even if the powers received by 150 from the splitter sub-system 140 vary significantly between the channels, due to the variation in power across the comb lines generated by resonator sub-system 130.

In some embodiments, a monitor photodetector subsystem 160, comprising an array of monitor photodetectors (MPDs), is present, one for each channel. Four MPDs (161-164) of the N present are shown in FIG. 1. Each MPD is coupled to the output of a corresponding SOA using a tap coupler that takes a small amount of the power in that SOA channel waveguide (typically around 1% but it may be lower or higher) that can be used to monitor the strength of the signal in that channel (comb line) and provide feedback to the corresponding SOA. The part of the power in each SOA channel waveguide that is not coupled to the corresponding MPD exits the comb source 100 as a comb source output. Four such comb source outputs (171-174) are shown in FIG. 1., in which each comb source output of light, characterized by its own individual dominant comb frequency, is carried by a corresponding waveguide, so that a device output 170 may be considered to be made up of N separately guided comb source outputs. Each comb source output may also carry light at one or more other comb frequencies, each with a power at least 10 dB lower than the dominant comb frequency in that comb source output.

In some other embodiments, not shown, the N comb source outputs may be combined by adding an inverse splitter system to multiplex the N comb source outputs, each at its own frequency, by feeding them into a single device output waveguide carrying all N comb source outputs.

FIG. 1 shows embodiments in which there is a small tap that couples part of the output from laser 111 through waveguide 181 to a reference sub-system 180. Reference sub-system 180 can provide locking of the laser to specific frequency, e.g. if the output comb should be centered on the ITU grid, or on some other specific frequency (e.g. atomic or molecular transition). Various types of reference sub-system can be used, including those based on atomic/molecular lines, or stable external resonators.

Couplers 120 are used in many locations on the PIC, and various designs can be used to provide optimized coupling values such as directional couplers, pulley couplers, multimode-interference couplers, Y-junctions, adiabatic couplers, inverse design couplers and others. In practice, loss inevitably occurs at couplers, so even if a tap coupler is used to tap a small percentage of the power entering it, say x %, the percentage that is untapped and passed through to the next component will typically be slightly less than (100-x)% of the input power, due to such loss.

FIG. 2 shows multiple arrangements of a resonator sub-system including the type shown in FIG. 1, as element 130.

In view 200, the basic configuration shown in FIG. 1 as element 130, is shown in more detail. The input signal, which is a single frequency input from the laser, is incident to the first resonator 201 that is coupled in all-pass configuration to the bus waveguide running horizontally from left to right at the bottom of the view, providing the output of the resonator sub-system. The first resonator can be tuned using tuning element 201a. In some embodiments, the tuning element 201a is a thermal tuner. In other embodiments, other tuning mechanisms like strain, an electro-optic effect or others can be used. The first resonator 201 is coupled to second resonator 202, often called an “auxiliary” resonator, that also comprises a tuning element 202a. The two resonators can be tuned to optimize the efficiency of the comb generation, as will be discussed below when describing FIG. 4.

In view 220, the resonator sub-system's input and output are coupled through first resonator 221 in add-drop configuration, first resonator 221 being coupled to second (“auxiliary”) resonator 222 as before. Both resonators have tuning elements (221a and 222a) to optimize performance.

In view 240, the resonator sub-system's input and output are coupled through both first resonator 241 and second resonators 242, arranged in add-drop configuration. Both resonators have tuning elements (241a and 242a) to optimize performance.

In view 260, very similar to view 200, the resonator sub-system's input and output are coupled through first resonator 261 in all-pass configuration, while first resonator 261 is coupled to second (“auxiliary”) resonator 262. Both resonators have tuning elements (261a and 262a) to optimize the performance. To further optimize the performance, the first resonator 261, in contrast to first resonator 201 in view 200, has a photonic crystal structure 263 that provides an additional degree of freedom in controlling dispersion. A photonic crystal structure is an optical nanostructure in which the refractive index changes periodically. This index periodicity affects the propagation of light, similarly to the way the atomic lattice in a semiconductor affects electron movement. Photonic crystal structures can be introduced to either of the arrangements shown in views 220 and 240 as well.

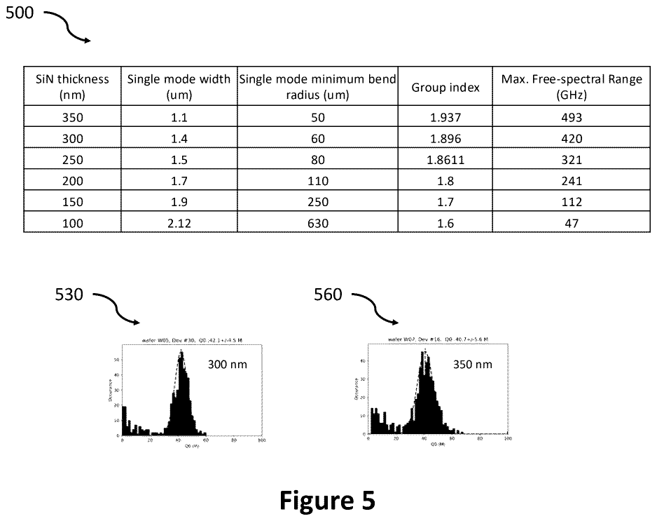

FIG. 2 shows only a few configurations of two resonators, and it is obvious that other configurations utilizing two resonators, or configurations utilizing three or more resonators are possible without departing from the spirit of invention. By carefully designing the coupling between the rings and the properties of each ring (such as their size, modal index (e.g. waveguide width) and coupling), it is possible to engineer the dispersion properties of the system to enhance the comb generation and/or provide flatter comb lines (with less power variation than a single resonator comb) even if nominal waveguide geometry does not support anomalous dispersion, which is generally the case for thinner silicon-nitride geometries as is known to someone skilled in the art, and as will be described below in the description of FIG. 5.

View 280 shows the spectrum of a typical input to the resonator sub-system, as could be provided by a single-frequency laser, and the resulting spectrum output from the resonator sub-system, showing a comb, with a large number of lines. In most cases (as shown in this view 280), the comb lines have different optical powers. However, they can be made more uniform and have higher power after passing throughSOA sub-system 150, as will be described in more detail with the help of FIG. 4. Further details on some trades in realizing resonators will be provided below in the description of FIG. 5.

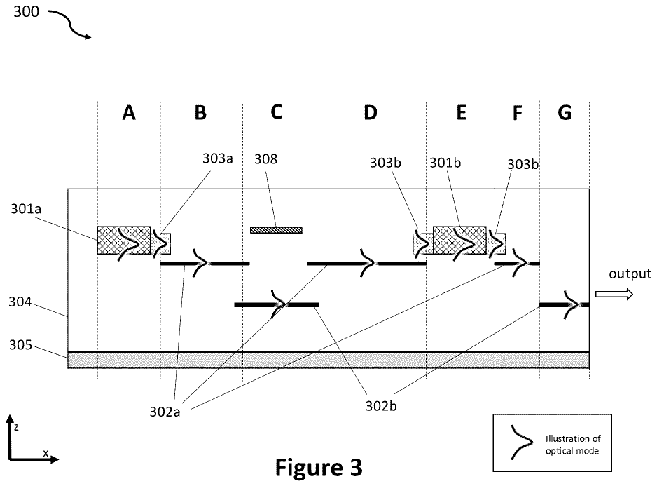

FIG. 3 shows a cross-section view of one embodiment of a photonic integrated circuit platform by which some embodiments of the present invention may be realized. The shown embodiment includes substrate 305. The substrate 305 can be any suitable substrate for semiconductor and dielectric processing, such as Si, InP, GaAs, quartz, sapphire, glass, GaN, silicon-on-insulator or other materials known in the art. Layer 304 provides optical cladding for layers 302a, 302b, 303a, 303b, 301a, and 301b that provide the core of an optical waveguide as described below. Cladding can be formed/deposited in multiple steps, and can also comprise multiple materials, but results in a refractive index lower than the refractive index of the core layers. In some embodiments, cladding 304 comprises SiO₂.

Layers 302a and 302b provide waveguide functionality, in which passive waveguides, splitters/couplers, resonators, filters, arrayed waveguide gratings (AWG), Echelle gratings, ring-resonators configured as add-drop filters, unbalanced Mach-Zehnder interferometers and other similar components can be realized. In the embodiment shown in FIG. 3, the two sub-layers are used with each layer optimized for particular functionality. Layer 302a is a general routing layer in which routing waveguides and couplers are realized. This layer also supports efficient coupling from active waveguides realized in layers 301a and 301b as will be described below. Layer 302b is an ultra-low-loss layer that is optimized to provide very high-quality resonators for comb-generation. As this layer has a thicker top cladding (from the top of layer 302b to the bottom of layer 301a) compared to that of layer 302a (from the top of layer 302a to the bottom of layer 301a), the impact of laser/amplifier and photodetector integration processing steps on propagation loss is significantly reduced, enabling higher quality factor resonators. This layer, in some embodiments, provides the resonator functionality, but can also provide PIC output functionality owning to potentially better matching of the output optical mode to an output fiber (not shown) leveraging the thicker dielectric claddings. Coupling from layer 302a to layer 302b and vice-versa in some embodiments utilizes inverse tapers. In some embodiments, layer 302a and/or 302b can comprise at least one of silicon-nitride (SiN), silicon-oxynitride (SiNOₓ), titanium-dioxide (TiO₂), tantalum-pentoxide (Ta₂O₅), (doped) silicon-dioxide (SiO₂), lithium-niobate (LiNbO₃), lithium-tantalate (LiTaO₃), rubidium-titanyl-phosphate (RTP), aluminum-nitride (AlN) or other suitable materials.

Layers 301a/301b make up what is commonly called an active device and may be multilayered and/or patterned to provide optical and electrical confinement as is known in the art of active semiconductor devices such as optical sources, amplifiers and detectors. Layers 301a/301b, in some embodiments, comprise at least one of GaAs, InP and/or GaN and their related ternary and quaternary compounds.

Efficient coupling between waveguides realized in layers 301a/301b and waveguides realized in layer 302a is facilitated by layers 303a/303b. Layers 303a/303b have a lower refractive index than layer 302a, and higher refractive index than layers providing cladding functionality (304). In some embodiments, layers 303a/303b comprise SiNOₓ or SiN, where the former allows precise refractive index control supporting optimization of the optical coupling as described in more detail below. The coupling utilizes butt-coupling assisted coupling as described in more detail in U.S. Pat. No. #10,641,959 B1 and U.S. Pat. No. #11,209,592 B2.

In this illustrative embodiment, the mode progression from left to right in FIG. 3 is as follows. Layer 303a serves as an intermediate waveguide core that in some embodiments accepts the profile of an optical mode supported by the waveguide for which layer 301a in the region marked “A” provides the core, captures it efficiently via butt-coupling, and gradually transforms it to mode profile shown in region marked “B” for which layer 302a provides the core. In some embodiments, layer 301a is used to realize laser functionality.

The mode guided in the waveguide for which layer 302a serves as the core is gradually transformed using taper structures to a mode that is guided in the waveguide for which layer 302b serves as the core. The mode supported in the waveguide for which layer 302b serves as the core in the region marked “C” is used to provide resonator functionality, owning to the thicker cladding in that region, that results in lower propagation losses. The mode guided in the waveguide for which layer 302b serves as the core is gradually transformed using taper structures to a mode that is guided in the waveguide for which layer 302a serves as the core as it travels from region “C” to region “D”. In some embodiments, layer 302a, is used to realize splitter functionality in the region marked “D”.

in some embodiments layer 303b serves as an intermediate waveguide core in the region marked “D” that gradually transforms the mode profile guided in the waveguide for which layer 302a provides the core to the mode profile guided in the waveguide for which layer 303b provides the core, before coupling this mode to the mode supported by the waveguide for which layer 301b in the region marked “E” provides the core. in some embodiments, layer 301b, is used to realize amplifier and photodetector functionality.

in some embodiments layer 303b serves as an intermediate waveguide core that accepts the profile of an optical mode supported by the waveguide for which layer 301b in the region marked “E”, captures it efficiently via butt-coupling, and gradually transforms it to the mode profile shown in the region marked “F” in the waveguide for which layer 302a provides the core.

The mode guided in the waveguide for which layer 302a serves as the core, in region “F”, is gradually transformed using taper structures to a mode that is guided in the waveguide for which layer 302b serves as the core in the region marked “G”. The mode supported in the waveguide for which layer 302b serves as the core in region “G” can be efficiently coupled to an output fiber, owing to the thicker cladding in that region, supporting larger mode sizes.

Layer 308 in region “C” is used to realize a tuner element. In this embodiment, the tuner element is simply a heater that changes the refractive index of an underlying resonator by changing the temperature distribution of the waveguide from which the resonator is made. Many additional tuner elements (not shown) can be introduced at various locations of the PIC, in order to tune the laser, splitter structure, and other components. Various types of tuner elements can be utilized, including electro-optic based tuners.

Optical mode transitions from layers 301a/301b to layers 303a/303b utilize butt-coupling, in which coupling efficiency is maximized by optimizing the mode shapes at the butt-coupled interface for maximum overlap, and optionally utilizing anti-reflectivity coatings (not shown). For butt-coupling, the waveguides do not overlap in the vertical dimension (z-axis in view 300).

Optical mode transitions from layers 301a/301b to layer 302a, and from layer 302a to layer 303b utilize evanescent coupling, in which waveguides overlap in the vertical dimension (z-axis in view 300). The waveguide dimensions are optimized to support evanescent coupling using tapers in at least one of the waveguides (whose cores are defined in layers 302a/302b, 303a/303b). Tapers are not visible in the x-z cross-section view of FIG. 3 but would be visible in an x-y view.

The refractive indices and dimensions of layers 303a/303b can be engineering to achieve two goals. The first goal is to better match optical mode profiles to improve the coupling efficiency of the butt-coupled interfaces between those layers and layers 301a/301b. The second goal is to take full advantage of tapered structures made either in those layers or in layer 302a, to improve the efficiency of evanescent coupling between 303a/303b and 302a. It should be noted that the requirements on taper dimensions for evanescent coupling are reduced as refractive index difference of layers 302a and 303a/303b is typically smaller than the refractive index difference between layer 301a/301b and 302a, so phase matching is simplified and does not require prohibitively narrow taper tips.

Active devices (formed using layers 301a/301b) also have electrical contacts (not shown) to provide electrical control signals, e.g. to inject carriers in the case where an optical semiconductor amplifier is formed. Similarly, tuner elements (308) have electrical contacts (not shown) to provide their electrical control signals.

An illustrative fabrication flow, in some embodiments could proceed as follows. Fabrication starts with a wafer substrate (305) on top of which a bottom sub-layer of cladding (304) is deposited/grown, followed by the deposition or bonding of a first waveguide core layer (302b). First waveguide core layer 302b is patterned and planarized before a first intermediate sub-layer of cladding (304) is deposited on top of it). Next, a second waveguide layer (302a) is deposited or bonded on top of the first intermediate sub-layer of cladding 304, patterned and suitably planarized, after which a second intermediate sub-layer of cladding (304) is deposited thereupon. This second intermediate sub-layer of cladding is significantly thinner than the first, usually being between 10 nm and 1000 nm thick. Layers 301a/301b are bonded onto the top surface of the second intermediate sub-layer (304). In some embodiments, layers 301a and 301b are identical and can be bonded in a single step. One example of this would be if the same layer is used to provide laser, amplifier and photodetector functionality. In other embodiments, layers 301a and 301b are different in composition and/or dimensions, and the process can include two bonding steps. In such embodiments, they can have significantly optimized structures, e.g. layer 301a could be providing optimized laser functionality, while layer 301b provides optimized amplifier functionality. The optimizations can include e.g. control of the confinement in the active (quantum well/quantum dot) region as well as internal loss, optical mode size, etc. as is known in the art of semiconductor lasers and amplifiers. After the bonding of layer(s) 301a/301b, several etch and deposition steps are typically performed, to form active devices as is known in the art, followed by deposition of a top sub-layer of cladding (304), addition of tuner elements (308), and finishing the process by creating vias and electrical contacts/pads (not shown). Common alignment mark(s) (not shown) are used to align process steps in forming the complete structure including the patterning of layers 301a/301b after bonding. In some embodiments, alignment marks are defined in at least one of the layers 302b/302a, 303a/303b, the marks not being visible in the x-z cross-section view 300, but they would be if an x-y view.

An advantage of this approach to fabrication (where layers 301a/301b are bonded to the partially processed wafer substrate before forming active structures) is that it is a wafer-scale approach, enabling fabrication and testing using wafer-scale techniques, lowering cost while providing very high alignment accuracy between layers 301a/301b and 302a/302b, as lithography is used for alignment between waveguides (while the bonding step is a fast operation with no fine alignment needed). This is in contrast to approaches where 301a/301b material would be pre-processed and then attached to the partially processes substrate wafer. In this case, the alignment of attached 301a/301b material (as waveguides are defined prior to bonding) would have to be very high which can be challenging to achieve reliably and at scale. In practice, lithography can achieve alignment tolerances of <100 nm or better across full die, which is typically an order of magnitude better than mechanical alignment.

FIG. 4 illustrates one embodiment of an algorithm 400 used to optimize the performance of a comb source of the present invention (such as one of those illustrated in FIG. 1) with improved control. In first step 405, the SOAs (150) are reverse biased, and laser (111) is powered on. The next step 410 is optional and is executed if the laser has to be locked to a reference sub-system 180. In this step the laser can be tuned (thermally, by current and/or by using dedicated tuner elements that tune wavelength by electro optic or other non-thermal means) to operate at a particular optical frequency that might be required by the system in which the source is intended to be deployed, e.g. to match a line in the ITU grid. Once properly tuned, a lock can be implemented to keep the laser locked to the reference.

From here, the algorithm proceeds to step 415, in which the resonator conditions are optimized. Here the photocurrents generated on the reverse biased SOAs, which act effectively as photodetectors, are monitored and used to control the resonator tuner elements. This can directly enable optimization of the resonator sub-system 130 for optimal performance, as both the number of generated lines, and their power distribution can be monitored via the reverse-biased SOAs (150) that act effectively as photodetectors.

The next step 420 is optional and can be executed if the splitter sub-system (140) is tunable. In this step the splitter sub-system response can be optimized for minimum insertion loss. In some cases, the order of steps 415 and 420 is switched, and in other cases they can be executed multiple times, e.g. first step 415, then step 420, and then step 415 again, and/or other combinations.

Finally, after the pump laser, resonator and splitter sub-system are optimized, the SOAs are forward biased and monitor photodetectors (160) are used to adjust the power of each comb line to meet some predetermined metric. In some embodiments the power variation between lines can be made smaller than 10 dB. In other embodiments, the power variation between lines can be kept smaller than 3 dB, and in yet other embodiments the power variation can be kept smaller than 0.5 dB.

FIG. 5 shows the results of a study tabulating some design trade-offs related to different resonator designs. In this study, the resonator is made in silicon-nitride, and calculations are carried out for operation around 1550 nm, but similar calculations can easily be performed for other material choices and wavelengths of operation. High-quality silicon-nitride is usually deposited using LPCVD (Low Pressure Chemical Vapor Deposition) that has a limitation on thickness at about 400 nm, before stress becomes an issue, and at these lower thicknesses, dispersion is usually normal. Work has been carried out using very thick silicon-nitride (typically >600 nm) that can provide anomalous dispersion, but such films often suffer from stress buildup, and it can be challenging to integrate lasers, amplifiers and photodetectors on them using wafer scale processes as described in relation to FIG. 3. Managing and optimizing dispersion is used to facilitate the efficiency of the comb generation and power in each of the lines including forming dispersive waves, as is known to someone skilled in the art. For this reason, the present invention utilizes two or more coupled rings to enhance comb generation efficiency by providing a different control on the dispersion even for SiN thicknesses below the anomalous dispersion threshold of about 600 nm (depending on wavelength of operation).

Table 500 in FIG. 5 shows calculated single-mode geometries for six silicon-nitride thicknesses ranging from 100 nm to 350 nm, and corresponding bend radius limitations and group indices. From these, we can calculate the maximum free-spectral range (FSR) which corresponds to the maximum frequency spacing that a resonator with each silicon-nitride thickness can achieve before the bend loss significantly impacts the achievable quality factor. Historically, silicon-nitride for resonators was thinner to support lower-propagation losses (as the mode is expanded into the cladding) and therefore enable higher quality factors, but this can place limitations on achievable FSRs, e.g. the 100 nm thick silicon-nitride can barely support 50 GHz spacings and cannot support spacings of 100 GHz or 200 GHz, which are very desirable in communication systems. Prior art suggests that moving to thicker silicon-nitride would result in significantly higher propagation losses, reducing the ability to generate large FSR combs on-chip, as this process usually leverages large power buildup in high-quality resonators to reduce the threshold of the comb generation. However, we have recently made significant improvements as shown in views 530 and 560 of FIG. 5. These views show measured intrinsic quality factors of silicon-nitride resonators exceeding 40 million with both 300 nm thickness (view 530) and 350 nm thickness (view 560) enabling us to make combs with FSRs of up to 500 GHz which is more suitable for many applications. The improvements include material optimizations including deposition recipes and planarization (to reduce both material losses and roughness induced losses), high temperature anneals (to solidify and purify films), and lithography optimizations to reduce sidewall roughness. This has enabled chip-scale integrated comb sources with ITU grid FSRs (100 GHz, 200 GHz) to be made in large scale manufacturing processes compatible with III-V integration, as described with the help of FIG. 3, while providing low comb threshold powers and enabling combs spanning large numbers of lines. With similar process quality improvements, the same quality factor improvements could be made with other material systems such as silicon-oxynitride (SiNOₓ), titanium-dioxide (TiO₂), tantalum-pentoxide (Ta₂O₅), lithium-niobate (LiNbO₃), lithium-tantalate (LiTaO₃), rubidium-titanyl-phosphate (RTP), aluminum-nitride (AlN) and/or others.

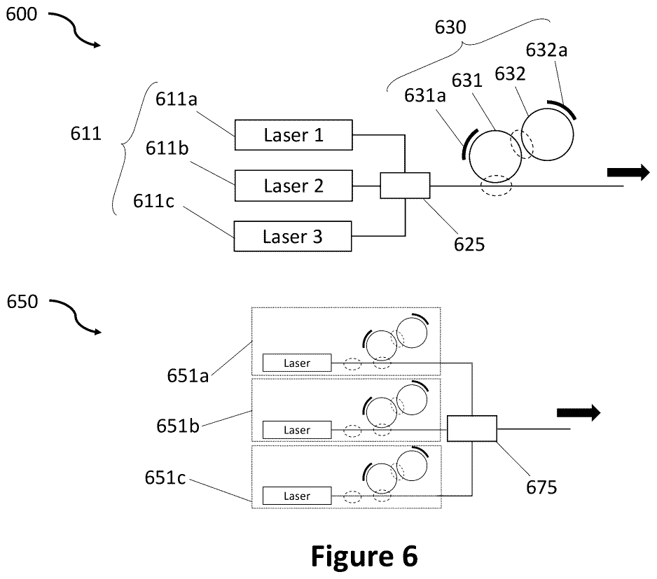

FIG. 6 shows two views, 600 and 650, of some embodiments of the present invention.

In view 600, multiple lasers (611a, 611b and 611c) are combined using combiner 625 and are used to pump the same resonator sub-system 630 comprising at least two resonators 631/632 with tuner elements 631a/632a. Combiner 625 can be realized in the form of various elements including, for example, directional couplers, pulley couplers, multimode-interference couplers, Y-junctions, adiabatic couplers, inverse design couplers, resonator-based couplers/filters, AWGs, and Echelle Gratings. The lasers can operate at different frequencies to extend the output of the comb. In some embodiments, lasers can operate at significantly different wavelengths, such as at 1310 nm, 1430 nm and 1550 nm, and the resonator sub-system can generate a comb output of 10 s of nanometers or wider around each of the three frequencies, resulting in a large number of total comb lines that can support additional data capacity. The comb outputs may then be fed into a splitter sub-system, such as that shown in FIG. 1.

In view 650, multiple laser-plus-resonator subsystems (651a, 651b and 651c) are coupled together via element 675 before reaching a splitter sub-system (not shown) such as that shown in FIG. 1. Each of the laser-plus-resonator subsystems can operate at a different wavelength range to extend the spectral width of the generated frequencies. Combiner 675 can be realized in the form of various elements including, for example, directional couplers, pulley couplers, multimode-interference couplers, Y-junctions, adiabatic couplers, inverse design couplers, resonator-based couplers/filters, AWGs, and Echelle Gratings.

In other embodiments, additional lasers and/or resonators (beyond the architectures shown in views 600 and 650) can be combined with a goal of optimizing the comb outputs before reaching splitter and amplifier sub-systems as shown in FIG. 1.

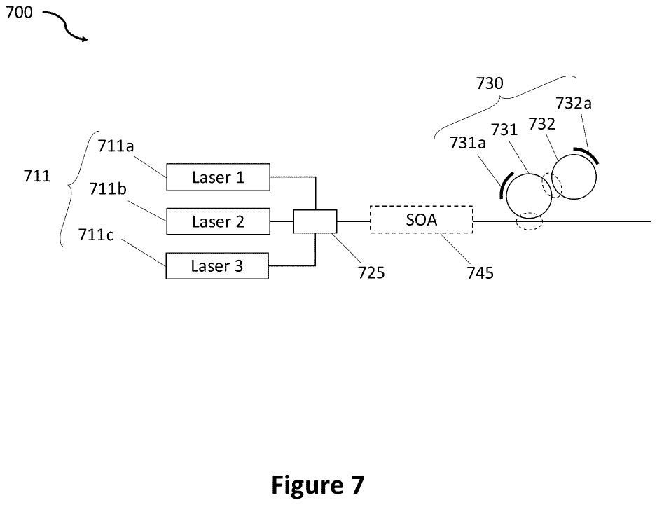

FIG. 7 shows one view 700 of an embodiment of present invention in which multiple lasers are used to provide redundancy to the system. In this particular case, laser outputs from each of three lasers (711a, 711b and 711c) are combined using combiner 725, but typically only one laser is powered and pumps the resonators sub-system 730, comprising at least two resonators 731/732 with tuner element 731a/732a, while the other two lasers are turned off. To better control the power, an optional semiconductor optical amplifier (SOA) 745 can be placed between the resonator sub-system and the lasers. If and when the laser that is powered on fails, one of the other lasers can be powered up, and in this way the reliability of the whole comb source can be significantly improved. Additional variations combining the architectures shown in FIG. 6 and FIG. 7 can be envisioned to increase the total number of lines/wavelengths and to improve reliability. It is obvious to someone skilled in the art that multiple variations of the above architectures that combine pump laser, resonators, splitters, amplifiers and photodetectors can be realized to provide improved comb source outputs as described above.

It is to be understood that these illustrative embodiments teach just several examples of photonic integrated circuit-based comb sources with improved control, and many similar arrangements can be further envisioned. Furthermore, such combs can be combined with multiple other components to provide additional functionality or better performance such as various filtering elements, amplifiers, monitor photodiodes, modulators, single-frequency lasers, widely tunable lasers, broadband optical sources and/or other photonic components.

Embodiments of the present invention offer many benefits. The integration platform enables scalable manufacturing of PICs made from multiple materials providing higher-performance and/or ability to operate in broadband wavelength range.

This present invention utilizes a process flow consisting typically of wafer-bonding a piece of compound semiconductor material (to realize lasers, amplifiers and photodetectors) onto a carrier wafer with dielectric waveguides (to also provide resonators) and subsequent semiconductor fabrication processes as are known in the art. It enables an accurate definition of optical alignment between components typically via a photo lithography step, removing the need for precise physical alignment. Such photo lithography-based alignment allows for scalable manufacturing using wafer scale techniques.

Embodiments of the optical devices described herein may be incorporated into various other devices and systems including, but not limited to, various communication, computing and/or consumer electronic devices, medical devices, timing devices, quantum devices, sensors and sensing systems.

It is to be understood that the disclosure teaches just a few examples of the illustrative embodiment and that many variations of the invention can easily be devised by those skilled in the art after reading this disclosure and that the scope of the present invention is to be determined by the following claims.

1. A device comprising:
a first element, comprising a first semiconductor laser, providing a laser output;
a second element, configured to produce a comb output, the second element comprising two or more resonators each with a resonator tuner element;
a third element, comprising a 1:N splitter where N>=3, configured to provide N third element outputs;
a fourth element, comprising N semiconductor optical amplifiers configured to generate N fourth element outputs;
a fifth element, comprising N waveguides, providing N comb source outputs;
wherein X % of the laser output of the first element is coupled to the second element, the comb output of the second element is coupled to the third element, the N third element outputs are coupled to the fourth element and Y % of each of the N fourth element outputs is coupled to the fifth element;
wherein each of X and Y are less than or equal to 100; and
wherein the first, second, third, fourth and fifth elements are realized as at least part of a photonic integrated circuit.

2. The device of claim 1,
additionally comprising a sixth element comprising a reference sub-system;
wherein (100-X-Z₁)% of the laser output from the first element is coupled to the sixth element via a first tap coupler, (X+Z₁) being less than 100.

3. The device of claim 1,
additionally comprising a seventh element comprising N photodetectors;
wherein (100-Y-Z₂)% of each of the N fourth element outputs is coupled to the seventh element via a corresponding one of N second tap couplers, (Y+Z₂) being less than 100.

4. The device of claim 1,
wherein the second element resonators are realized as silicon-nitride based waveguides.

5. The device of claim 4,
wherein the thickness of the silicon-nitride based waveguides is >100 nm and <400 nm.

6. The device of claim 5,
wherein an intrinsic quality factor characterizing at least one of the second element resonators is greater than 20 million.

7. The device of claim 1,
wherein the second element resonators are arranged in all-pass configuration.

8. The device of claim 1,
wherein the second element resonators are arranged in add-drop configuration.

9. The device of claim 1,
wherein at least one of the second element resonators comprises a photonic crystal structure.

10. The device of claim 1,
wherein the third element additionally comprises a splitter tuner element.

11. The device of claim 6,
wherein N>16, and wherein optical power variation across the dominant comb frequencies in the N fifth element waveguides is <0.5 dB.

12. The device of claim 6,
wherein N>64, and wherein optical power variation across the dominant comb frequencies in the N fifth element waveguides is <3 dB.

13. The device of claim 6,
wherein N>128, and wherein optical power variation across the dominant comb frequencies in the N fifth element waveguides is <10 dB.

14. The device of claim 1,
wherein the first element comprises one or more additional semiconductor lasers to provide improved reliability and/or provide a larger number of comb lines than would be provided by the first semiconductor laser alone.

15. The device of claim 1,
wherein the first element is realized in a first layer, the second and fifth elements are realized in a second layer, the third element is realized in a third layer, and the fourth element is realized in a fourth layer of the photonic integrated circuit, fabricated on a common substrate.

16. The device of claim 1,
wherein coupling between the first and second elements includes at least one intermediate waveguide structure that is at least party butt-coupled to an active waveguide structure in the first element.

17. The device of claim 1,
wherein coupling between the third and fourth element includes at least one intermediate waveguide structure that is at least party butt-coupled to an active waveguide structure in the fourth element.

18. The device of claim 1, wherein the N comb source outputs carried by the N fifth element waveguides comprise a device output.

19. The device of claim 1,
additionally comprising an eighth element;
wherein the eight element comprises an inverse splitter sub-system that combines the N comb source outputs into a single device output waveguide, forming a device output.

20. The device of claim 1,
wherein the device is configured such that each comb source output provided by the N fifth element waveguides includes light at a dominant comb frequency with a power at least 10 dB higher than any other comb frequency in that comb source output.
